(19) United States
(12) Patent Application Publication
(10) Pub. No.: US 2024/0332741 A1
(43) Pub. Date: Oct. 3, 2024

(54) ALL-SOLID-STATE BATTERY AND METHOD FOR MANUFACTURING ALL-SOLID-STATE BATTERY

(71) Applicant: HONDA MOTOR CO., LTD., Tokyo (JP)

(72) Inventors: Terumi Furuta, Wako-shi (JP); Takuya Taniuchi, Wako-shi (JP)

(21) Appl. No.: 18/588,006

(22) Filed: Feb. 27, 2024

(30) Foreign Application Priority Data
Mar. 31, 2023 (JP) 2023-058542

(51) Int. Cl. H01M 50/477; H01M 4/02; H01M 4/13; H01M 50/474

(52) U.S. Cl. CPC H01M 50/477; H01M 4/13; H01M 50/474; H01M 2004/028

(57) ABSTRACT

Disclosed is an all-solid-state battery including: a positive electrode for an all-solid-state battery; a negative electrode for an all-solid-state battery; and a solid-state electrolyte layer that is disposed between the positive electrode and the negative electrode, wherein the positive electrode includes a positive electrode current collector, a positive electrode active material layer formed on the positive electrode current collector, and an insulating member provided on an outer periphery of the positive electrode active material layer, wherein the positive electrode active material layer has a first inclined portion that is inclined such that the positive electrode active material layer widens away from the positive electrode current collector, and wherein the negative electrode active material layer contains metallic lithium or a lithium alloy.

### CROSS-REFERENCE TO RELATED APPLICATION

Priority is claimed on Japanese Patent Application No. 2023-058542, filed Mar. 31, 2023, the content of which is incorporated herein by reference.

### BACKGROUND OF THE INVENTION

### Field of the Invention

The present invention relates to an all-solid-state battery and a method for manufacturing an all-solid-state battery.

### Description of Related Art

For example, an all-solid-state battery is manufactured by: cutting out a sheet, in which a positive electrode active material layer is formed by coating a positive electrode current collector with an electrode mixture, an insulating member is formed on the outer periphery of the positive electrode active material layer, and a solid-state electrolyte is disposed on the upper surface of the positive electrode active material layer, in an arbitrary shape; alternately stacking positive electrodes and negative electrodes; and performing press-forming.

In the positive electrode of the all-solid-state battery obtained in this way, the positive electrode active material layer has an inclined portion that is inclined such that the positive electrode active material layer widens toward the positive electrode current collector (see, for example, Patent Document 1).

### PATENT DOCUMENTS

[Patent Document 1] Japanese Unexamined Patent Application, First Publication No. 2020-173954

### SUMMARY OF THE INVENTION

In a case where the positive electrode active material layer has the inclined portion that is inclined such that the positive electrode active material layer widens toward the positive electrode current collector, the current is concentrated at the boundary between the positive electrode active material layer and the insulating member, resulting in local lithium deposition on the negative electrode side including metallic lithium or a lithium alloy.

In order to solve the above-mentioned problems, an object of the present application is to suppress current concentration at the boundary between the positive electrode active material layer and the insulating member in the positive electrode of the all-solid-state battery, and to suppress local lithium deposition on the negative electrode side including metallic lithium or a lithium alloy. This in turn contributes to energy efficiency.

In order to achieve the above object, the present invention provides the following embodiments.

[1] An all-solid-state battery including:
a positive electrode for an all-solid-state battery in which a positive electrode active material layer is formed on a positive electrode current collector;
a negative electrode for an all-solid-state battery in which a negative electrode active material layer is formed on a negative electrode current collector; and
a solid-state electrolyte layer that is disposed between the positive electrode for an all-solid-state battery and the negative electrode for an all-solid-state battery,
wherein the positive electrode for an all-solid-state battery includes the positive electrode current collector, a positive electrode active material layer formed on the positive electrode current collector, and an insulating member provided on an outer periphery of the positive electrode active material layer,
wherein the positive electrode active material layer has a first inclined portion that is inclined such that the positive electrode active material layer widens away from the positive electrode current collector, and
wherein the negative electrode active material layer contains metallic lithium or a lithium alloy.

In the all-solid-state battery of the present invention, the positive electrode active material layer has the first inclined portion that is inclined such that the positive electrode active material layer widens away from the positive electrode current collector, and thus it is possible to suppress concentration of a current at the boundary between the positive electrode active material layer and the insulating member and it is possible to suppress local lithium deposition on a side of the negative electrode for an all-solid-state battery containing metallic lithium or a lithium alloy.

[2] The all-solid-state battery according to [1], wherein the insulating member has a second inclined portion that is inclined such that the insulating member widens toward the positive electrode current collector.

The insulating member has the second inclined portion that is inclined such that the insulating member widens toward the positive electrode current collector, and thus it is possible to suppress concentration of a current at the boundary between the positive electrode active material layer and the insulating member.

[3] A method for manufacturing the all-solid-state battery according to [1] or [2], comprising:
a step of forming, on a positive electrode current collector, a plurality of insulating members having inclined portions that are inclined such that the insulating members widen toward the positive electrode current collector at intervals;
a step of forming a positive electrode active material layer between the adjacent insulating members on the positive electrode current collector to obtain a positive electrode for an all-solid-state battery; and
a step of stacking the positive electrode for an all-solid-state battery and the negative electrode for an all-solid-state battery via a solid-state electrolyte layer.

According to the method for manufacturing an all-solid-state battery of the present invention, the all-solid-state battery of the present invention can be obtained.

[4] The method for manufacturing an all-solid-state battery according to [3], further comprising a pressurizing step of pressurizing the positive electrode current collector, the positive electrode active material layer, and the insulating member after forming the positive electrode active material layer.

If the pressurizing step of pressurizing the positive electrode current collector, the positive electrode active material layer, and the insulating member is provided after forming the positive electrode active material layer, the positive electrode active material layer having the first inclined portion that is inclined such that the positive electrode active material layer widens away from the positive electrode current collector can be easily formed.

[5] The method for manufacturing an all-solid-state battery according to [4], further comprising a cutting step of cutting the insulating member and the positive electrode current collector after the pressurizing step.

If the cutting step of cutting the insulating member and the positive electrode current collector is provided after the pressurizing step, the all-solid-state battery of a predetermined size is obtained.

According to the present invention, it is possible to suppress current concentration at the boundary between the positive electrode active material layer and the insulating member in the positive electrode of the all-solid-state battery, and to suppress local lithium deposition on the negative electrode side including metallic lithium or a lithium alloy.

### BRIEF DESCRIPTION OF THE DRAWINGS

FIG. 1 is a cross-sectional view showing an example of an all-solid-state battery according to an embodiment of the present invention.

FIG. 2 is a diagram showing the results of simulating the current density of the all-solid-state battery according to the embodiment of the present invention.

FIG. 3 is a cross-sectional view showing an example of an all-solid-state battery of the related art.

FIG. 4 is a diagram showing the results of simulating the current density of the all-solid-state battery of the related art.

FIG. 5 is a cross-sectional view showing a method for manufacturing an all-solid-state battery according to an embodiment of the present invention.

FIG. 6 is a plan view showing the method for manufacturing an all-solid-state battery according to the embodiment of the present invention.

### DETAILED DESCRIPTION OF THE INVENTION

Hereinafter, embodiments of the present invention will be described in detail.

### [All-Solid-State Battery]

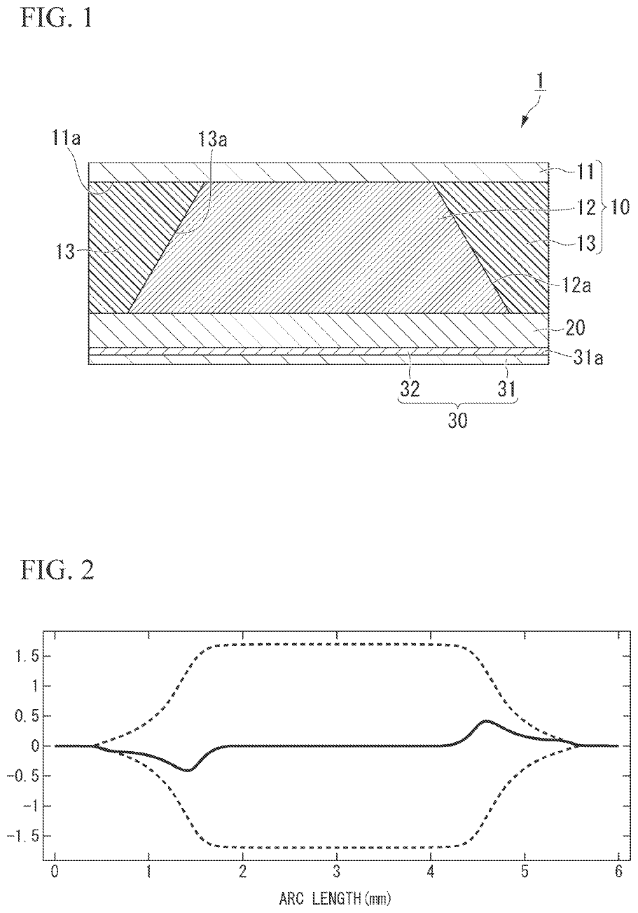

FIG. 1 is a cross-sectional view showing an example of an all-solid-state battery according to an embodiment of the present invention. In the drawings used in the following description, to make characteristics easy to understand, characteristic portions may be enlarged for convenience in some cases, and dimensional ratios and the like of each constituent element are not limited to those illustrated.

The all-solid-state battery 1 includes a positive electrode for an all-solid-state battery (hereinafter sometimes abbreviated as “positive electrode”) 10, a solid-state electrolyte layer 20, and a negative electrode for an all-solid-state battery (hereinafter sometimes abbreviated as “negative electrode”) 30. In the all-solid-state battery 1, the positive electrode 10 and the negative electrode 30 are stacked via a solid-state electrolyte layer 20.

The positive electrode 10 includes a positive electrode current collector 11, a positive electrode active material layer 12 formed on one main surface 11a of the positive electrode current collector 11, and an insulating member 13 provided on the outer periphery of the positive electrode active material layer 12.

The positive electrode active material layer 12 has a first inclined portion 12a that is inclined such that the positive electrode active material layer widens away from one main surface 11a of the positive electrode current collector 11 (in a thickness direction of the positive electrode active material layer 12). The angle of the first inclined portion 12a with respect to one main surface 11a of the positive electrode current collector 11 is not particularly limited, and is adjusted according to the capacity of the positive electrode active material layer 12, the thickness of the solid-state electrolyte layer 20, and the like. In the present embodiment, the current density of the all-solid-state battery 1 is derived by simulation, and the angle of the first inclined portion 12a with respect to one main surface 11a of the positive electrode current collector 11 is adjusted on the basis of the results of the simulation.

The insulating member 13 has a second inclined portion 13a that is inclined such that the insulating member 13 widens toward one main surface 11a of the positive electrode current collector 11 (in a thickness direction of the positive electrode current collector 11). The angle of the second inclined portion 13a with respect to one main surface 11a of the positive electrode current collector 11 is not particularly limited, and is adjusted according to the capacity of the positive electrode active material layer 12, the thickness of the solid-state electrolyte layer 20, and the like.

The negative electrode 30 includes a negative electrode current collector 31 and a negative electrode active material layer 32 formed on one main surface 31a of the negative electrode current collector 31.

### (Positive Electrode)

The positive electrode current collector 11 is preferably made of at least one highly conductive material. Examples of the highly conductive material include materials with high conductivity, for example, metals containing at least one metallic element selected from silver (Ag), palladium (Pd), gold (Au), platinum (Pt), aluminum (Al), copper (Cu), chromium (Cr), and nickel (Ni), alloys such as stainless steel, or non-metals such as carbon (C). Aluminum, nickel, or stainless steel is preferable in consideration of manufacturing cost in addition to high conductivity. Further, aluminum is preferable because it hardly reacts with the positive electrode active material, the negative electrode active material, and the solid-state electrolyte. For this reason, when aluminum is used for the positive electrode current collector 11, the internal resistance of the all-solid-state battery 1 can be reduced.

Examples of the shape of the positive electrode current collector 11 include any known shape such as a foil shape, a plate shape, a mesh shape, a nonwoven fabric shape, and a foam shape. Further, in order to improve the adhesion with the positive electrode active material layer 12, carbon and the like may be disposed on the surface of the positive electrode current collector 11, or the surface may be roughened. The surface of the positive electrode current collector 11 can become an interface between the positive electrode current collector 11 and the positive electrode active material layer 12 by forming the positive electrode active material layer 12 on the positive electrode current collector 11.

The positive electrode active material layer 12 contains a positive electrode active material that exchanges electrons with lithium ions. The positive electrode active material is not particularly limited as long as it is a material that can reversibly release and absorb lithium ions and can transport electrons, and any known positive electrode active material that can be applied to the positive electrode of the all-solid-state lithium ion battery can be used. Examples of the positive electrode active material include composite oxides such as lithium cobalt oxide (LiCoO₂), lithium nickel oxide (LiNiO₂), lithium manganese oxide (LiMn₂₀₄), a solid solution oxide (Li₂MnO₃-LiMO₂ (M=Co, Ni, and the like)), lithium-manganese-nickel-cobalt oxide (LiNiₓMn_{y}Co_{z}O₂, x+y+z=1), and olivine-type lithium phosphate oxide (LiFePO₄); conductive polymers such as polyaniline and polypyrrole; sulfides such as Li₂S, CuS, a Li—Cu—S compound, TiS₂, FeS, MoS₂, and a Li—Mo—S compound; a mixture of sulfur and carbon; and the like. The positive electrode active material may be made of only one kind of the above-mentioned materials, or may be formed of two or more kinds of the materials.

The positive electrode active material layer 12 may contain a conductive additive from the viewpoint of improving the conductivity of the positive electrode 10. As the conductive additive, a conductive additive that can generally be used for all-solid-state lithium ion batteries can be used. Examples of the conductive additive include carbon black such as acetylene black and Ketjen black; carbon fiber; vapor grown carbon fiber; graphite powder; and a carbon material such as carbon nanotubes. The conductive additive may be made of only one kind of the above-mentioned materials, or may be formed of two or more kinds of the materials.

Further, the positive electrode active material layer 12 may include a binder that serves to bind the positive electrode active materials to each other and to bind the positive electrode active material and the positive electrode current collector 11 to each other.

In the present embodiment, the positive electrode active material layer 12 is formed on one main surface 11a of the positive electrode current collector 11, but the present invention is not limited to this. The positive electrode active material layer 12 may be formed on both main surfaces of the positive electrode current collector 11. Further, when the positive electrode active material layer 12 has a three-dimensional porous structure such as a mesh shape, a nonwoven fabric shape, or a foamed shape, the positive electrode active material layer 12 may be provided integrally with the positive electrode current collector 11.

The insulating material forming the insulating member 13 is not particularly limited, and examples of the insulating material include an insulating oxide such as alumina, a resin such as polyvinylidene fluoride (PVDF), rubber such as styrene-butadiene rubber (SBR), and the like.

### (Solid-State Electrolyte Layer)

The solid-state electrolyte layer 20 is disposed between the positive electrode active material layer 12 and the negative electrode active material layer 32.

The solid-state electrolyte is not particularly limited as long as it has lithium ion conductivity and insulation properties, and materials generally used for all-solid-state lithium ion batteries can be used. Example of the solid-state electrolyte can include inorganic solid-state electrolytes such as sulfide solid-state electrolyte materials, oxide solid-state electrolyte materials, halide solid-state electrolytes, and lithium-containing salts, polymer-based solid-state electrolytes such as polyethylene oxide, gel-based solid-state electrolytes containing lithium-containing salts and lithium ion conductive ionic liquids, and the like. Among these, sulfide solid-state electrolyte materials are preferred from the viewpoints of high conductivity of lithium ions, good structural formability by pressing, and good interfacial bonding properties.

The form of the solid-state electrolyte material is not particularly limited, but can be, for example, particulate.

The solid-state electrolyte layer 20 may contain an adhesive for imparting mechanical strength and flexibility.

The solid-state electrolyte layer 20 may be in the form of a sheet having a porous substrate and a solid-state electrolyte held by the porous substrate. The form of the porous substrate is not particularly limited, but examples thereof include woven fabric, nonwoven fabric, mesh cloth, a porous membrane, an expanded sheet, a punched sheet, and the like. Among these forms, non-woven fabric is preferred from the viewpoint of handling properties that allow the filling amount of the solid-state electrolyte to be further increased.

Preferably, the porous substrate is made of an insulating material. As a result, the insulation properties of the solid-state electrolyte layer 20 can be improved. Examples of the insulating material include resin materials such as nylon, polyester, polyethylene, polypropylene, polytetrafluoroethylene, ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, and acrylic resin; natural fibers such as hemp, wood pulp, and cotton linter; glass; and the like.

### (Negative Electrode)

Like the positive electrode current collector 11, the negative electrode current collector 31 is preferably made of at least one highly conductive material. Examples of the highly conductive material include materials with high conductivity, for example, metals containing at least one metallic element selected from silver (Ag), palladium (Pd), gold (Au), platinum (Pt), aluminum (Al), copper (Cu), chromium (Cr), and nickel (Ni), alloys such as stainless steel, or non-metals such as carbon (C). Copper, nickel, or stainless steel is preferable in consideration of manufacturing cost in addition to high conductivity. Further, stainless steel is preferable because it hardly reacts with the positive electrode active material, the negative electrode active material, and the solid-state electrolyte. For this reason, when stainless steel is used for the negative electrode current collector 31, the internal resistance of the all-solid-state battery can be reduced.

Examples of the shape of the negative electrode current collector 31 include any known shape such as a foil shape, a plate shape, a mesh shape, a nonwoven fabric shape, and a foam shape. Further, in order to improve the adhesion with the negative electrode active material layer 32, carbon and the like may be disposed on the surface of the negative electrode current collector 31, or the surface may be roughened. The surface of the negative electrode current collector 31 can become an interface between the negative electrode current collector 31 and the negative electrode active material layer 32 by forming the negative electrode active material layer 32 on the negative electrode current collector 31.

The negative electrode active material layer 32 includes a negative electrode active material that exchanges electrons with lithium ions. The negative electrode active material is not particularly limited as long as it is a material that can reversibly release and absorb lithium ions and can transport electrons, and any known negative electrode active material that can be applied to the negative electrode of the all-solid-state lithium ion battery can be used. Examples of the negative electrode active material include carbonaceous materials such as natural graphite, artificial graphite, resin charcoal, carbon fiber, activated carbon, hard carbon, and soft carbon; alloy-based materials mainly composed of tin, tin alloys, silicon, silicon alloys, gallium, gallium alloys, indium, indium alloys, aluminum, and aluminum alloys; conductive polymers such as polyacene, polyacetylene, and polypyrrole; metallic lithium; lithium alloys; and lithium-titanium composite oxides (for example, Li₄Ti₅O₁₂). The negative electrode active material may be made of only one kind of the above-mentioned materials, or may be formed of two or more kinds of the materials.

The negative electrode active material layer 32 may contain a conductive additive, a binder, and the like. These materials are not particularly limited, but for example, materials similar to those used for the positive electrode active material layer 12 described above can be used.

As described above, according to the all-solid-state battery 1 of the present embodiment, the positive electrode active material layer 12 of the positive electrode 10 has the first inclined portion 12a that is inclined such that the positive electrode active material layer 12 widens away from one main surface 11a of the positive electrode current collector 11, and thus it is possible to suppress concentration of a current at the boundary between the positive electrode active material layer 12 and the insulating member 13. As a result, it is possible to suppress local lithium deposition on a side of the negative electrode 30 including metallic lithium or a lithium alloy.

Here, the results of simulating the current density of the all-solid-state battery 1 are shown in FIG. 2. In FIG. 2, an upper broken line shows the total current density (the magnitude), a lower broken line shows the current density in a y direction, and a solid line shows the current density in an x direction.

As shown in FIG. 2, no current concentration is observed in the all-solid-state battery 1. As shown in FIG. 1, the insulating member 13 has the second inclined portion 13a that is inclined such that the insulating member 13 widens toward one main surface 11a of the positive electrode current collector 11. Therefore, in the all-solid-state battery 1, it is possible to suppress local lithium deposition on a side of the negative electrode 30 including metallic lithium or a lithium alloy.

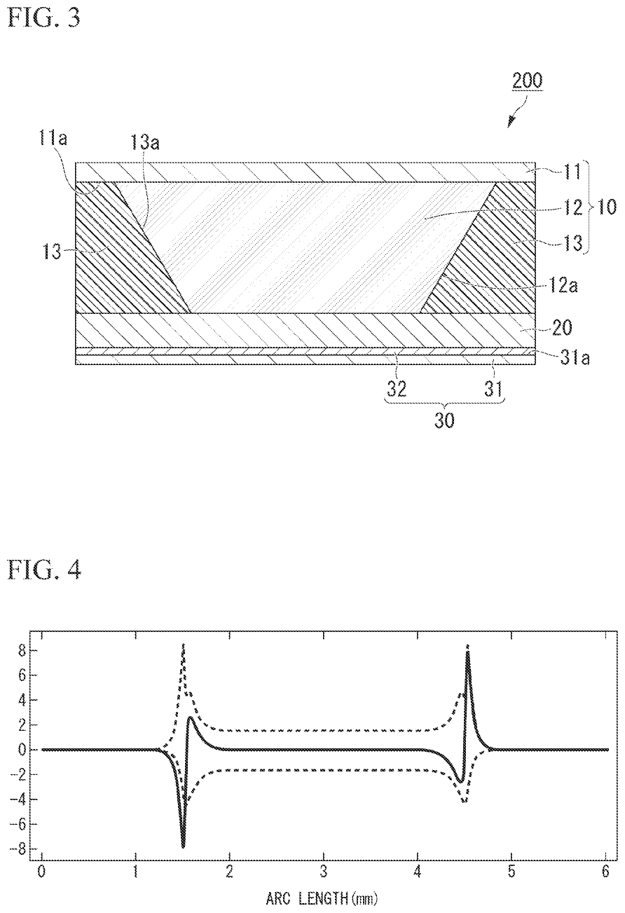

FIG. 3 shows a cross-sectional view of an example of an all-solid-state battery of the related art. In FIG. 3, the same constituent elements as those shown in FIG. 1 are designated by the same reference signs, and the description thereof will be omitted.

In an all-solid-state battery 200, the positive electrode active material layer 12 has a first inclined portion 12a that is inclined such that the positive electrode active material layer 12 is narrowed in a direction away from one main surface 11a of the positive electrode current collector 11. Further, the insulating member 13 has the second inclined portion 13a that is inclined such that the insulating member 13 is narrowed toward one main surface 11a of the positive electrode current collector 11.

Here, the results of simulating the current density of the all-solid-state battery 200 are shown in FIG. 4. In FIG. 4, an upper broken line shows the total current density (the magnitude), a lower broken line shows the current density in a y direction, and a solid line shows the current density in an x direction.

As shown in FIG. 4, current concentration is observed in the all-solid-state battery 200. Therefore, in the all-solid-state battery 200, lithium is locally deposited on a side of the negative electrode 30 including metallic lithium or a lithium alloy.

[Method for Manufacturing all-Solid-State Battery]

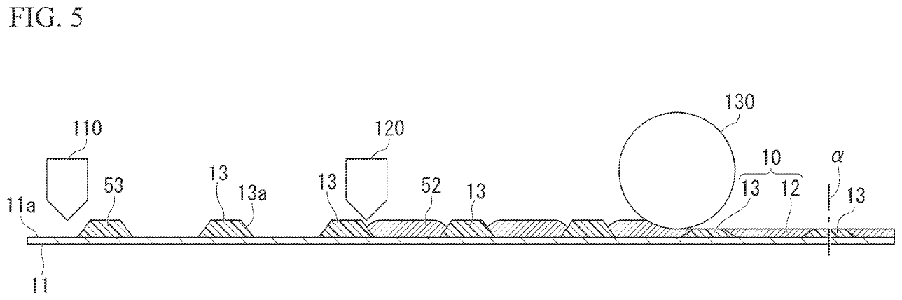

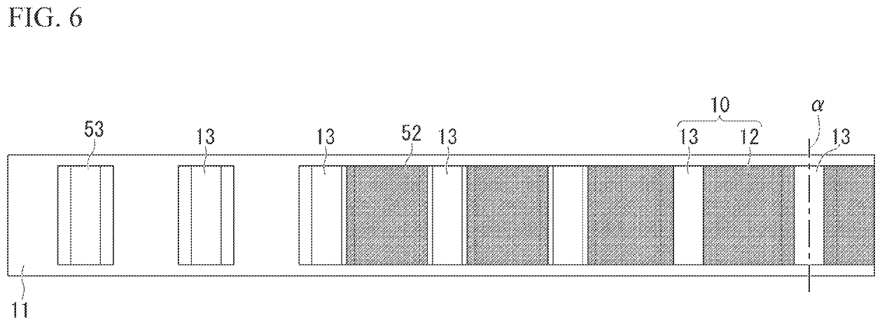

FIG. 5 is a cross-sectional view showing a method for manufacturing an all-solid-state battery according to an embodiment of the present invention. FIG. 6 is a plan view showing the method for manufacturing an all-solid-state battery according to the embodiment of the present invention. In FIGS. 5 and 6, the same constituent elements as those shown in FIG. 1 are designated by the same reference signs, and the description thereof will be omitted.

In the drawings used in the following description, to make characteristics easy to understand, characteristic portions may be enlarged for convenience in some cases, and the dimensional ratios and the like of the constituent elements are not limited to those illustrated.

The method for manufacturing an all-solid-state battery according to the present embodiment includes a step of forming, on a positive electrode current collector, a plurality of insulating members having inclined portions that are inclined such that the insulating members widen toward the positive electrode current collector at intervals (hereinafter referred to as an “insulating member forming step); a step of forming a positive electrode active material layer between the adjacent insulating members on the positive electrode current collector to obtain a positive electrode for an all-solid-state battery (hereinafter referred to as a “positive electrode forming step”); and a step of stacking the positive electrode for an all-solid-state battery and the negative electrode for an all-solid-state battery via a solid-state electrolyte layer (hereinafter referred to as a “stacking step”).

### (Insulating Member Forming Step)

In the insulating member forming step, one main surface 11a of the positive electrode current collector 11 is coated with an insulating material 53 by an insulating material coating device 110, the insulating material 53 is hardened, and a plurality of insulating members 13 having the second inclined portions 13a that are inclined such that the insulating members 13 widen toward one main surface 11a of the positive electrode current collector 11 are formed at intervals.

### (Positive Electrode Forming Step)

In the positive electrode forming step, one main surface 11a of the positive electrode current collector 11 between the adjacent insulating members 13 is coated with a positive electrode mixture containing a positive electrode active material by a positive electrode mixture coating device 120, the positive electrode active material layer 12 is formed, and the positive electrode 10 is obtained.

### (Stacking Step)

In the stacking step, the positive electrode 10 manufactured in the positive electrode forming step, the solid-state electrolyte layer 20 and the negative electrode manufactured by any known method are stacked in this order by any known method to form a stacked product, and the stacked product is pressurized in the stacking direction by press forming to obtain the all-solid-state battery 1.

In the stacking step, as shown in FIG. 5 or 6, when the positive electrode 10 is formed on the elongated positive electrode current collector 11, a corresponding elongated negative electrode and solid-state electrolyte layer may be stacked to form an elongated stacked product, and press formed; or the positive electrode 10 formed by cutting in the cutting process described below, a corresponding negative electrode and solid-state electrolyte layer may be stacked to form a stacked product, and press formed.

### (Pressurizing Step)

In the positive electrode forming step, it is preferable to include a pressurizing step of pressurizing the positive electrode current collector 11, the positive electrode active material layer 12, and the insulating member 13 by a pressing roller 130 after forming the positive electrode active material layer 12. Through the pressurizing step, the positive electrode active material layer 12 having the first inclined portion 12a that is inclined such that the positive electrode active material layer 12 widens away from one main surface 11a of the positive electrode current collector 11 can be easily formed between the adjacent insulating members 13.

### (Cutting Step)

In the positive electrode forming step, it is preferable to include a cutting step of cutting the insulating member 13 and the positive electrode current collector 11 after the pressurizing step. Through the cutting step, the all-solid-state battery 1 of a predetermined size is obtained.

According to the method for manufacturing an all-solid-state battery of the present embodiment, the all-solid-state battery of the above-described embodiment can be obtained.

Although the embodiments of the present invention have been described in detail above, the present invention is not limited to the above embodiments, and various modifications and changes can be made within the gist of the present invention described in the claims.

### Explanation of References

1 All-solid-state battery
10 Positive electrode for all-solid-state battery (positive electrode)
11 Positive electrode current collector
12 Positive electrode active material layer
13 Insulating member
20 Solid-state electrolyte layer
30 Negative electrode for all-solid-state battery (negative electrode)
31 Negative electrode current collector
32 Negative electrode active material layer

What is claimed is:

1. An all-solid-state battery comprising:
a positive electrode for an all-solid-state battery in which a positive electrode active material layer is formed on a positive electrode current collector;
a negative electrode for an all-solid-state battery in which a negative electrode active material layer is formed on a negative electrode current collector; and
a solid-state electrolyte layer that is disposed between the positive electrode for an all-solid-state battery and the negative electrode for an all-solid-state battery,
wherein the positive electrode for an all-solid-state battery includes the positive electrode current collector, the positive electrode active material layer formed on the positive electrode current collector, and an insulating member provided on an outer periphery of the positive electrode active material layer,
wherein the positive electrode active material layer has a first inclined portion that is inclined such that the positive electrode active material layer widens away from the positive electrode current collector, and
wherein the negative electrode active material layer contains metallic lithium or a lithium alloy.

2. The all-solid-state battery according to claim 1, wherein the insulating member has a second inclined portion that is inclined such that the insulating member widens toward the positive electrode current collector.

3. A method for manufacturing the all-solid-state battery according to claim 1, comprising:
a step of forming, on a positive electrode current collector, a plurality of insulating members having inclined portions that are inclined such that the insulating members widen toward the positive electrode current collector at intervals;
a step of forming a positive electrode active material layer between the adjacent insulating members on the positive electrode current collector to obtain a positive electrode for an all-solid-state battery; and
a step of stacking the positive electrode for an all-solid-state battery and the negative electrode for an all-solid-state battery via a solid-state electrolyte layer.

4. The method for manufacturing an all-solid-state battery according to claim 3, further comprising a pressurizing step of pressurizing the positive electrode current collector, the positive electrode active material layer, and the insulating member after forming the positive electrode active material layer.

5. The method for manufacturing an all-solid-state battery according to claim 4, further comprising a cutting step of cutting the insulating member and the positive electrode current collector after the pressurizing step.
